(19) United States
(12) Patent Application Publication
(10) Pub. No.: US 2025/0380072 A1
(43) Pub. Date: Dec. 11, 2025

(54) PROTECTIVE PART FOR SPEAKER WITH CURVED SURFACES

(71) Applicant: SAGEMCOM BROADBAND SAS, Bois-Colombes (FR)

(72) Inventors: Jérémy STANGALINI, Bois-Colombes (FR); Luke MAIRONI, Bois-Colombes (FR)

(21) Appl. No.: 19/232,215

(22) Filed: Jun. 9, 2025

(30) Foreign Application Priority Data
Jun. 11, 2024 (FR) FR2406194

(51) Int. Cl. H04R 1/02

(52) U.S. Cl. CPC H04R 1/025

(57) ABSTRACT

A protective part, arranged to be assembled with a sound box that includes a first side box portion and a first end box portion, the first end box portion including a first convex external surface and extending from the first side box portion. The protective part includes a side protective portion and an end protective portion, the end protective portion comprising a first concave inner surface, complementary to the first convex external surface, and extending from the side protective portion; a positioning device arranged to guide the protective part into a predefined position on the sound box.

### DESCRIPTION

The invention relates to the field of acoustic speakers.

### BACKGROUND

It is considered to design an acoustic speaker having curved external surfaces, and in particular a speaker with a “capsule” shape. This speaker can optionally comprise a support enabling to position it vertically on a flat surface (of a piece of furniture, for example). The speaker can also be placed directly in a horizontal position on this flat surface.

The speaker is, for example, a “satellite” speaker intended to be connected to a device configured to broadcast sound content, such as a set-top box (STB). The set-top box itself possibly integrates one or more loudspeakers.

Such a speaker typically comprises a sound box. This is a waterproof casing in which one or more loudspeakers are integrated. The casing can be constituted as a single part or can be obtained by the assembly of a plurality of parts.

The sound box, which also has a shape close to that of a capsule, defines a technical volume necessary for the implementation of the technical functions of the audio part of the speaker. The box delimits the acoustic volume, and integrates the loudspeakers and the connections for bringing the audio signals to the loudspeakers. This technical volume can also be used to integrate components implementing “transversal” functions: control, communication (Wi-Fi interface, for example), electrical power supply, etc.

The acoustic speaker also comprises one or more protective parts mounted on the box and which cover (at least) the loudspeaker diaphragms to protect them from external aggressions. These protective parts comprise holes to let out the sounds generated by the loudspeakers. These protective parts also enable to give the speaker a certain aesthetic appearance. A fabric sometimes covers the protective parts in full or in part, which then also fulfil the support function of said fabric.

With reference to FIG. 1, such a capsule-shaped speaker 1 is known, which comprises two protective half-shells 2a, 2b, which are assembled on the front face of the sound box. The sound box comprises a plurality of loudspeakers 3, each of which has its diaphragm positioned at the front face of the box. The protective half-shells 2a, 2b comprise holes 4 located opposite the diaphragms of the loudspeakers 3, and both a protective function and an aesthetic function.

In general, on a capsule speaker, the mounting and the dismounting of the protective parts is quite complex, in particular due to their curved surfaces. Furthermore, each protective part is designed with respect to a very particular acoustic configuration, and cannot be adapted to other acoustic configurations, and in particular to other loudspeaker arrangements. This requires the speaker manufacturer to completely redesign new protective parts when changing the acoustic configuration of the speaker. Furthermore, the user cannot easily customise their speakers by replacing the protective parts with other parts of a different appearance.

### OBJECT

The object of the invention relates to a protective part for an acoustic speaker having curved external surfaces, which can be easily adapted to different acoustic configurations of the speaker, and which can be easily mounted and removed.

### SUMMARY

In order to achieve this aim, a protective part is proposed, arranged to be assembled with a sound box that comprises a first side box portion and a first end box portion, the first end box portion comprising a first convex external surface and extending from the first side box portion,
the protective part comprising:
   a side protective portion and an end protective portion, the end protective portion comprising a first concave inner surface, complementary to the first convex external surface, and extending from the side protective portion;
   a positioning device arranged to guide the protective part into a predefined position on the sound box during the assembly of the protective part with the sound box, and to maintain the protective part in this predefined position;
the protective part being arranged such that when assembled with the sound box, the side protective portion and the end protective portion of the protective part respectively cover the first side box portion and the first end box portion of the sound box.

The protective part therefore, comprises a side protective portion that covers the first side box portion and an end protective portion that covers the first end box portion of the sound box.

The protective part can therefore, protect at least one loudspeaker having its diaphragm located at the first side box portion of the box, and/or at least one loudspeaker having its diaphragm located at the first end box portion of the box. The protective part can comprise holes enabling sounds to come out of the speaker, which are positioned facing the loudspeaker diaphragms.

The protective part can therefore, be very easily adapted to different acoustic configurations of the speaker by adding holes in the appropriate places.

Thanks to the positioning device, the protective part is guided to its “final” position during the assembly. The protective part can therefore, be very easily mounted and removed.

In addition, a protective part as previously described is proposed, in which the end protective portion extends such that, when the protective part is assembled with the sound box, the end protective portion also covers part of a second side box portion of the sound box, opposite the first side box portion.

In addition, a protective part as previously described is proposed, in which the side protective portion extends such that, when the protective part is assembled with the sound box, the side protective portion also covers a part of a second end box portion of the sound box, opposite the first end box portion.

In addition, a protective part as previously described is proposed, the first side box portion of the sound box comprising a second convex external surface, the side protective portion of the protective part comprising a second concave inner surface complementary to the second convex external surface.

In addition, a protective part as previously described is proposed, the sound box comprising a central part cylindrically-shaped and two ends of hemispherically-shaped, the first side box portion belonging to the central part and the first end box portion at one of the ends.

In addition, a protective part as previously described is proposed, the positioning device comprising at least one magnet which is positioned on an inner wall of the side protective portion and which is located near an edge of the side protective portion.

In addition, a protective part as previously described is proposed, comprising a first magnet positioned near an edge of a free end of the side protective portion, and two second magnets each positioned near a side edge distinct from the side protective portion and near the end protective portion.

In addition, a protective part as previously described is proposed, the positioning device further comprising at least one pin arranged to centre the protective part on the sound box during the assembly of the protective part and the sound box, the at least one pin being positioned near an edge of a free end of the end protective portion, and being arranged to be assembled by elastic nesting in a complementary hole formed on the sound box.

In addition, a protective part as previously described is proposed, further comprising a fixing device arranged to fix and to lock the protective part on the box, the fixing device comprising at least one tab that extends from an edge of a free end of the end protective portion and which is intended to be fixed to a second side box portion of the sound box, opposite the first portion of the side box.

In addition, a protective part as previously described is proposed, in which at least one of the side protective portions and the end protective portion comprises holes intended to let out sounds generated by at least one loudspeaker of the sound box having a diaphragm positioned opposite said holes.

In addition, an acoustic speaker comprising a sound box and a protective part as previously described is proposed.

In addition, an acoustic speaker as previously described is proposed, the sound box comprising at least a first loudspeaker having a diaphragm positioned at the first side box portion.

In addition, an acoustic speaker as previously described is proposed, the sound box comprising at least a second loudspeaker having a diaphragm positioned at the first end box portion.

The invention will be better understood in light of the following description of a particular and non-limiting embodiment of the invention.

### BRIEF DESCRIPTION OF THE DRAWINGS Reference will be made to the accompanying drawings, among which:

FIG. 1 is a perspective view of a speaker of the prior art;

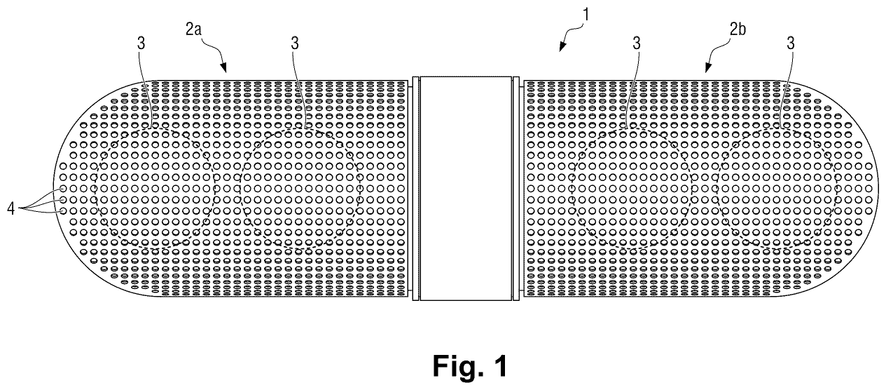

FIG. 2 is a perspective view of a speaker comprising the protective part;

FIG. 3 is an exploded view of this speaker;

FIG. 4 is a rear perspective view of the protective part;

FIG. 5 is a rear perspective view of the sound box assembled with the protective part;

FIG. 6 shows side views of the speaker and its support, before and after mounting the support on the speaker, according to a “table stand” mounting configuration;

FIG. 7 is a Figure similar to FIG. 6, but in a three-wire configuration;

FIG. 8 shows a front view of the support in the “table stand” configuration, and a front view of the support in the “wall mount” configuration;

FIG. 9 shows views of the support according to a particular embodiment, before and after folding the curved portion;

FIG. 10 shows a plurality of views showing the support according to a particular embodiment, in which the curved portion is headed on the base.

### DETAILED DESCRIPTION

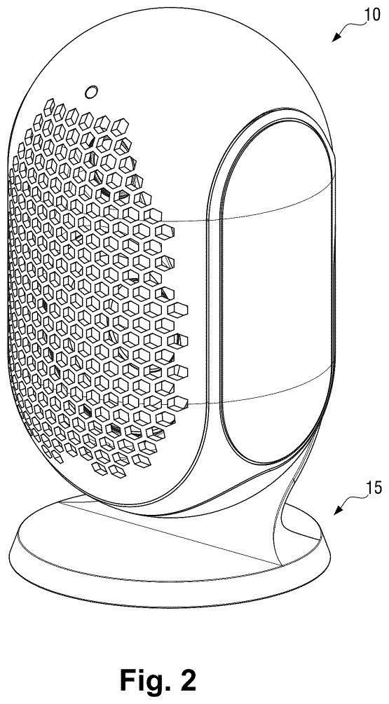

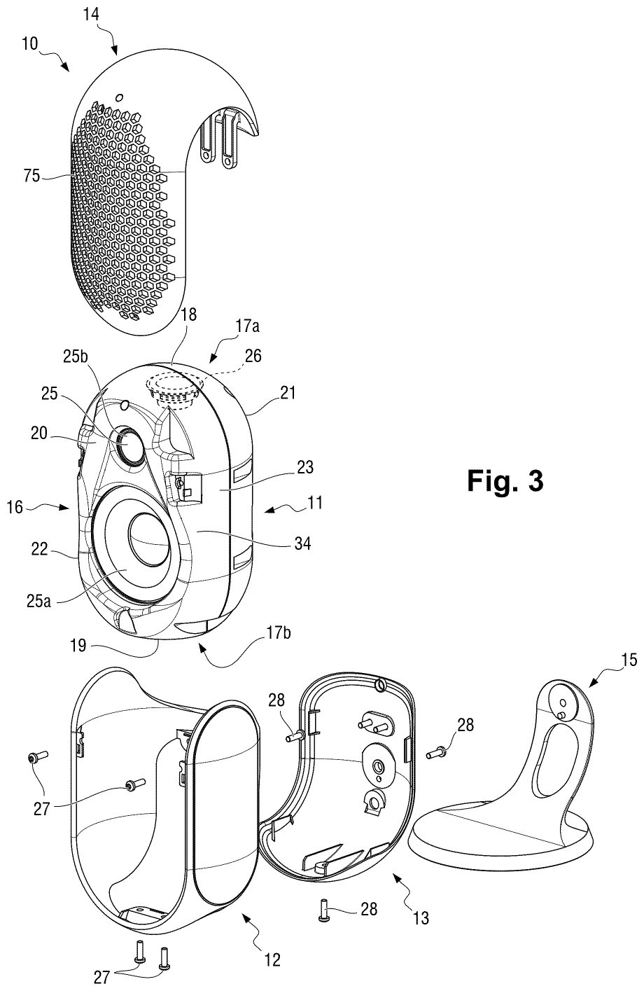

With reference to FIGS. 2 and 3, the acoustic speaker 10 is here a portable speaker which comprises curved external surfaces and more precisely has the shape of a “capsule”.

The acoustic speaker 10 comprises:
a sound box 11;
a first shell 12;
a second shell 13;
a protective part 14;
a support 15.

In the nominal operating position, the speaker 10 is positioned vertically. All the positioning terms used here must be interpreted considering that the speaker 10 is in this nominal operating position.

The sound box 11 comprises a central portion 16 and two ends 17a, 17b, hemispherically-shaped.

The end 17a forms a upper face 18 of the box 11. The end 17b forms a lower face 19 of the box 11. The central part 16 comprises side faces comprising a front face 20, a rear face 21, a left face 22 and a right face 23 of the box 11.

The sound box 11 also has the general shape of a capsule, but which is flattened at its front face 20 and its rear face 21. All the external surfaces of the box 11 are curved surfaces.

Here, two first loudspeakers 25 are integrated in the sound box 11 (the loudspeaker diaphragms can be seen in FIG. 3). The loudspeaker 25a is a Woofer type loudspeaker. This is a loudspeaker that reproduces low frequencies, for example, of between 100 Hz and 2 kHz. The term woofer is also used to designate this type of loudspeaker.

The loudspeaker 25b is a Tweeter type speaker. This is a loudspeaker that reproduces high frequencies, for example, of between 2 kHz and 20 kHz. The term treble loudspeaker is also used to designate this type of loudspeaker. The diameter of the diaphragm of the loudspeaker 25a is greater than the diameter of the diaphragm of the loudspeaker 25b.

The loudspeaker 25a is integrated in the sound box 11 such that its diaphragm is positioned, for example, at a lower portion of the front face 20 of the sound box 11. The loudspeaker 25b is integrated in the sound box 11 such that its diaphragm is positioned, for example, at an upper portion of the front face 20 of the sound box 11. The first shell 12 aims to protect the left face 22 and the right face 23 of the box 11. The first shell 12 is fixed to the box by screws 27.

The second shell 13 aims to protect the rear face 21 and the lower face 19 of the box 11. The second shell 13 is fixed to the box by screws 28.

The protective part 14 aims in particular to protect the front face 20 and the upper face 18 of the box 11.

The support 15 will be described below in this description.

There is now interest, more particularly, to the protective part 14 and the way in which it is assembled with the box 11.

The box 11 comprises a first side box portion 20 and a first end box portion 18. The first end box portion 18 extends from the first side box portion 20.

The first side box portion 20 is here the front face 20 of the box 11 and the first end box portion 18 is here the upper face 18 of the box 11 (hemispherically-shaped as has been seen). The first end box portion 18 therefore, comprises a first convex external surface 33, due to the hemispherical shape of the upper end 17a of the box 11. The first side box portion 20 comprises itself, a second convex external surface 34, because the front face 20 of the box 11 bulges forwards.

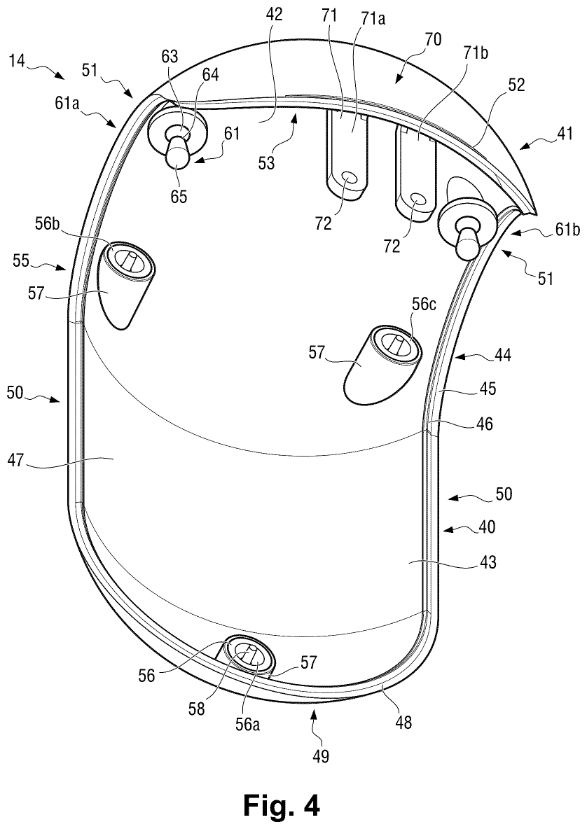

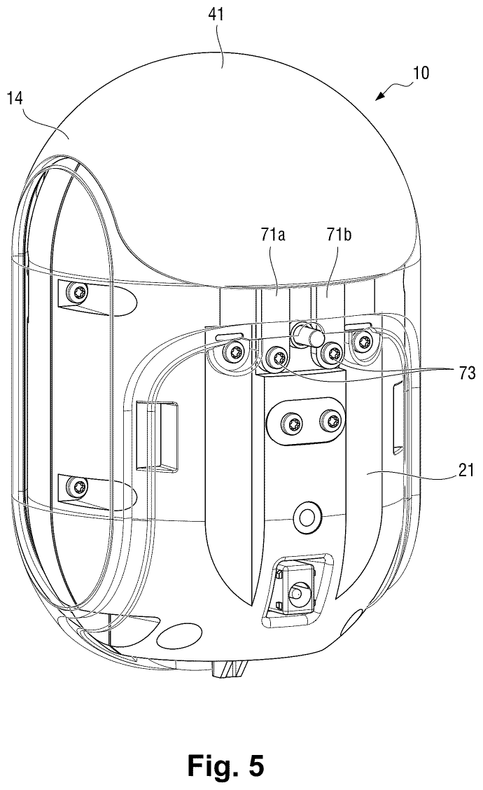

With reference to FIGS. 4 and 5, the protective part 14 comprises a side protective portion 40 and an end protective portion 41. The end protective portion 41 extends from the side protective portion 40. The end protective portion 41 comprises a first concave inner surface 42, which is complementary to the first convex external surface 33 of the first end box portion 18 of the box 11. The side protective portion 40 of the protective part 14 comprises a second concave inner surface 43, which is complementary to the second convex external surface 34 of the first side box portion 20 of the box 11.

Thus, when the protective part 14 is assembled with the sound box 11, the side protective portion 40 and the end protective portion 41 of the protective part 14 respectively cover the first side box portion 20 and the first end box portion 18 of the sound box 11. The side protective portion 40 thus forms a front face of the acoustic speaker 10 and the end protective portion 41 thus forms an upper face of the acoustic speaker 10.

Here, the end protective portion 41 of the protective part 14 extends such that, when the protective part 14 is assembled with the sound box 11, the end protective portion 41 also covers a portion of a second side box portion 21 of the box 11, opposite the first side box portion 20. The second side box portion 21 is here the rear face 21 of the box 11. As can be clearly seen in FIG. 5, the end protective portion 41 also covers an upper portion of this rear face 21.

Similarly, the side protective portion 40 of the protective part 14 extends such that, when the protective part 14 is assembled with the sound box 11, the side protective portion 40 extends to also cover a portion of a second end box portion 19 opposite the first end box portion 18. The end protective portion 40 also covers a portion of the lower face 19 of the box 11.

The edge 44 of the protective part 14 comprises, over the entire circumference of the protective part 14, a bearing surface 45 and a chamfer 46 that connects the inner wall of the protective part 14 and the bearing surface 45.

When the protective part 14 is mounted on the box 11, the bearing surface 45 rests on the first shell 12.

The edge 48 of the free end 49 of the side protective portion 40 of the protective part 14 has a semicircular shape. The side edges 50 of the central portion of the side protective portion 40 are rectilinear. The side edges 51 of the end protective portion 41 have a semicircular shape. The edge 52 of the free end 53 of the end protective portion 41 has a rectilinear central portion and rounded ends.

The protective part 14 further comprises a positioning device 55, which enables to guide the protective part 14 into a predefined position on the sound box 11 during the assembly of the protective part 14 with the box 11, and to maintain the protective part 14 in this predefined position.

The positioning device 55 comprises at least one magnet 56 which is positioned on the inner wall 47 of the side protective portion 40 of the protective part 14, and which is located near an edge of the side protective portion 40.

The positioning device 55 comprises here, a first magnet 56a positioned near the central portion of the edge 48 of the free end 49 of the side protective portion 40, and two second magnets 56b, 56c, each positioned near a side edge 50 distinct from the side protective portion 40 and near the end protective portion 41. The two second magnets 56b, 56c are therefore, located in an upper part of the inner wall 47 of the side protective portion 40.

The positioning device 55 comprises three cylindrical studs 57, made of plastic, that extend from the inner wall 47 of the side protective portion 40. Each magnet 56a, 56b and 56c also has a cylindrical shape (washer shape) and is inserted into one of the studs 57.

In the central portion of each stud 57, there is a plastic pin 58 which is intended to fix the associated magnet 56 by heading.

By definition, the heading of a plastic part is the equivalent of a riveting and enables to connect two parts to each other by deformation of material. In the case of plastic, the deformation is carried out by applying heat or ultrasound. Joining by heading is advantageous insofar as it does not require any additional part for the assembly, thus avoiding any risk of vibration and reducing the bulk compared to existing fixing techniques. Furthermore, joining by heading enables to ensure a very robust connection.

Each magnet 56 could be fixed differently in its stud 57, by gluing for example.

The box 11 also comprises magnets, which are not shown in the Figures. These magnets comprise two magnets positioned at the side edges of the front face 20 of the box, and a magnet positioned at the lower face 18 of the box 11. These magnets are integrated in the thickness of the box 11.

When an individual (factory technician, after-sales service technician, customer, etc.) assembles the protective part 14 with the box 11, the individual approaches the side protective portion 40 of the protective part 14, from the front face 18 of the box 11. The attraction between the magnets 56 and the magnets of the box 11 brings the protective part 14 into a predefined position on the box 11. This position is the position shown in FIGS. 2 and 5.

The magnets 56 enable both to facilitate the mounting of the protective part 14, and to ensure perfect positioning of the protective part 14 on the box 11.

The positioning device 55 further comprises at least one pin 61 that extends from the inner wall 42 of the end protective portion 41, which is positioned near the edge 52 of the free end 53 of the end protective portion 41, and which is arranged to be inserted into a complementary hole formed on the sound box 11.

Here, the positioning device 55 comprises two centering pins 61a, 61b positioned at the rounded ends of the edge 52 of the free end 53 of the end protective portion 41. The complementary holes, not shown in the Figures, are formed on the upper face of the sound box 11.

Each pin 61 comprises a base 63, a central portion 64 and a ball-shaped end 65. The central portion 64 is thinner than the base 63 and the end 65, and thus forms a groove. The groove and the end 65 enable to assemble the pin 61 in the associated complementary hole of the box 11, by elastic nesting.

The centering pins 61 enable to centre the end protective portion 41 of the protective part 14 on the upper face 18 of the box 11, and therefore, the protective part 14 on the box 11. The magnets 56 and the pins 61 therefore, enable to perfectly position and centre the protective part 14, even if it is manufactured with relatively large manufacturing tolerances.

The centering pins 61 also enable to maintain n the protective part 14 in position on the box 11, but without locking it.

The centering pins 61 also enable to prevent the protective part 14 from vibrating when the loudspeakers 25 are operating and therefore, to avoid the generating of interfering noise connected to this vibration phenomenon.

The protective part 14 further comprises here, a fixing device 70 arranged to fix the protective part 14 on the box 11.

The fixing device 70 comprises at least one fastening tab 71 that extends from the edge 52 of the free end 53 of the end protective portion 41, and which is intended to be fixed to the second side box portion 21 of the box 11—i.e. to its rear face 21.

Here, the fixing device 70 comprises two tabs 71a, 71b that extend longitudinally from the central portion of the edge 52 and in the direction of mounting the protective part 14 on the sound box 11.

Each tab 71 comprises at its free end a hole 72 adapted to cooperate with a screw 73. The screws 73 therefore, pass through the holes 72 and are screwed into the rear face 21 of the sound box 11, thereby, enabling to fix and lock the protective part 14 to the sound box 11. The screws 73 form two securing points for the protective part 14 on the sound box 11.

The fastening tabs 71 and the rest of the fixing part 14 form a single part obtained by moulding using a single mould.

It is noted, however, that the fastening tabs 71 are not necessary.

If the fastening tabs 71 are not present, the magnets 56 and the centering pins 61 enable to maintain and fix the protective part 14 on the box 11, but without locking it. The protective part 14 can then be very easily positioned and fixed on the box 11, but also be remove from the box 11, without the need for tools. Thus, the protective part 14 can be easily assembled in the factory or during a maintenance operation (after-sales, for example). The protective part 14 can also be very easily replaced by the user (customisation).

If the fastening tabs 71 are present, the protective part 14 is locked on the box 11 and the user cannot easily replace it himself.

It is observed that the positioning device 55 and the fixing device 70 are particularly advantageous since, unlike other assembly means, they enable to position and fix the protective part 14 on the box 11 without impacting the working volume of the box.

for example, an assembly via a “slider” solution could have been considered. During assembly, the protective part is then, for example, positioned above the box, then it slides in the slider downwards the box, until it covers the upper face, a portion of the rear face, the front face and a portion of the lower face of the box. This solution is less interesting because to enable a vertical assembly by sliding the protective part vertically on the box, it would have been necessary to “cut” in the box, an entire front portion of the box, to allow the lower end of the protective part to pass through.

The side protective portion 40 of the protective part 14 here, comprises holes 75 which pass through said side protective portion 40 and which are intended to let out sounds from the speaker 10 generated by the loudspeakers 25 of the sound box 11, each of which has its diaphragm positioned at the front face 20 of the box 11 and therefore, opposite said holes 75. The holes 75 are for example, arranged in a honeycomb structure, which enables to maximise the number of holes 75 while stiffening the side protective portion 40 at the holes 75.

Optionally, a fabric can entirely or partially cover the protective part 14, which then also performs the support function of said fabric. Preferably, the fabric covers the holes 75, which enables to prevent foreign bodies from penetrating into the speaker 10.

The protective part 14 is very advantageous.

In the embodiment described here, the box 11 comprises at least one first loudspeaker 25 (two in this case) having a diaphragm positioned at the first side box portion 20. The side protective portion 40 therefore, comprises holes 75 for letting through the sounds, whereas the end protective portion 41 does not comprise any.

However, the sound box 11 could also comprise, for example, at least one second loudspeaker having its diaphragm positioned at the first end box portion (upper face 18—up-firing configuration). In this case, the end protective portion of the protective part can also comprise holes. Holes could also be formed over the entire protective part.

The box can of course comprise both one or more first loudspeaker(s) and one or more second loudspeaker(s).

The second loudspeaker 26 is shown schematically in FIG. 3.

It is therefore, sufficient to add holes in the protective part 14 to adapt it to different acoustic configurations of the speaker.

The protective part 14 thus protects the first loudspeaker (here, the first loudspeakers 25a, 25b) and the second loudspeaker 26 of the sound box.

The protective part 14 can therefore, be very easily adapted to different configurations or types of speakers, and for example, to speakers intended to render:
an audio channel on two audio channels (for example, a Tweeter loudspeaker and a Woofer loudspeaker) in the case where the speaker has two front loudspeakers, as is the case in the embodiment described here;
two audio channels with one channel per channel (for example, surround and up-firing configuration); or
an upward channel (up-firing configuration).

There is now interest, more precisely, to the support 15 of the speaker 10.

It is known that, on the market, there are different types of speaker supports. Some supports only enable to place the speaker on a horizontal surface (for example, on a table) whereas other supports only enable to attach the speaker on a vertical surface (for example, wall mounting).

Nevertheless, a same support does not enable to position the speaker on a horizontal surface (for example, on a piece of furniture) or on a vertical surface (for example, against a wall).

There is therefore, a need to design a versatile speaker support, i.e. a single support capable of installing/fixing a speaker on different types of external supports (horizontal or vertical). In particular, the speaker support must fulfil the following two functions:
the so-called “table stand” function for positioning the speaker on a horizontal surface;
the so-called “wall mount” function for positioning the speaker on a vertical surface.

The support must also have a shape adapted to the capsule speaker and its curved external surfaces.

The support must ensure aesthetic coherence with the shape of the speaker, in particular, in the case of a capsule-shaped speaker, i.e. one having curved surfaces.

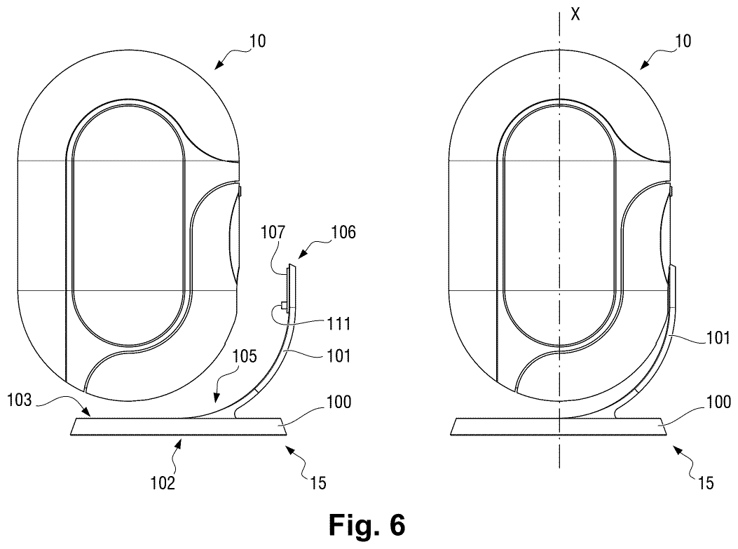

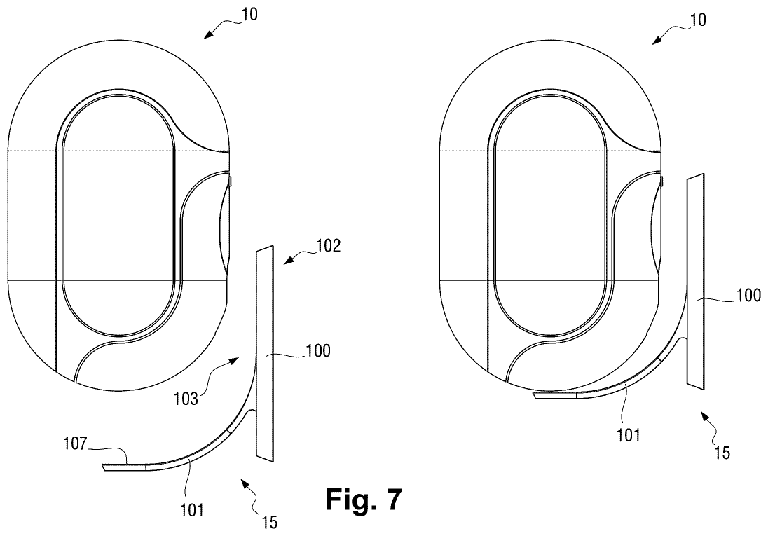

With reference to FIGS. 6 and 7, the support 15 of the speaker 10 comprises:
a base 100;
a curved portion 101.

The base 100 is generally flat-shaped and comprises a first face 102 and a second face 103. The first face 102 is intended to be in contact with an external support (for example, a table, a wall).

The curved portion 101 extends from the second face 103. The curved portion 101 comprises a first end 105 connected to the base 100 and a second free end 106. The curved portion 101 extends radially from the base 100 from its first end 105 to its second end 106.

Preferably, the curved portion 101 comprises a flat surface 107, oriented perpendicularly to the base 100, and comprising fastening means for fixing the flat surface 107 on a surface of the speaker 10. Here, the flat surface 107 of the curved portion 101 is located at the second end 106 of the curved portion 101.

FIG. 6 illustrates the first mounting configuration of the support on the speaker. This configuration is called “table stand”.

In this configuration, the first face 102 of the base 100 of the support 15 is placed on a flat horizontal surface (of a table, for example), and the fixing of the curved portion 101 to the speaker 10 is done from the rear of the speaker 10. The flat surface 107 is therefore, fixed to the rear face of the speaker 10.

FIG. 7 illustrates the second configuration for mounting the support 15 on the speaker 10. This configuration is called a “wall mount”.

In this configuration, the first face 102 of the base 100 of the support 15 is attached to the wall and the fixing of the curved portion 101 to the speaker 10 is carried out below the speaker 10. The flat surface 107 is therefore, fixed to the lower face of the speaker 10.

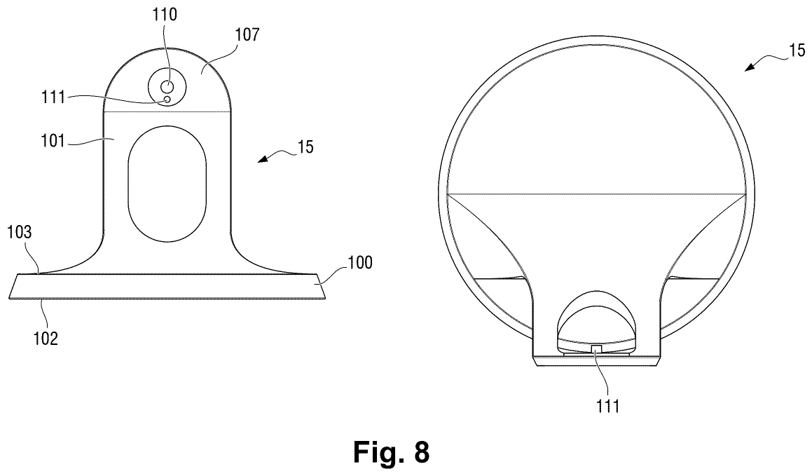

FIG. 8 shows front views of the support 15 in the “table stand” configuration (left drawing) and in the “wall mount” configuration (right drawing).

Preferably, the base 100 and the curved portion 101 of the support 15 are formed as one-piece (i.e. as a single part, for example, of aluminum).

For example, the surface of the base 100 is sized so as to ensure the stability of the speaker 10, when it is fixed to the curved portion 101 of the support 15, in particular in the “wall mount” configuration.

The base 100 comprises fastening means for fixing the support on a surface of the external support (for example, by screwing the support 15 on a wall). For example, these fastening means comprise one or more tapped holes formed in the thickness of the base and intended to receive a screw or knurled screw. These fastening means are not shown here.

The base 100 is arranged such that, when the speaker 10 and the support 15 are assembled, the axis of revolution X of the speaker 10 coincides with the centre of the base 100. Also, the surface of the base 100 of the support 15, in contact with the table, is sized such that the projection of the centre of gravity of the speaker 10 is fits within said surface.

Preferably, the curved portion 101 has a bend radius greater than the bend radius of the curved external surface of the capsule speaker 10, such that the curved portion 101 follows the curved shape of the speaker 10 without, however, risking of coming into contact with it.

The flat surface 107 of the second end 106 of the curved portion 101 comprises fastening means for fixing the support to the speaker, either to the rear face of the speaker according to the first mounting configuration, or to the lower portion of the speaker according to the second mounting configuration. The fastening means comprise for example, one or more holes or openings 110, each intended to receive a screw or knurled screw. Here, the fastening means comprise a single tapped hole 110.

Consequently, the capsule speaker 10 comprises one or more tapped holes arranged opposite the hole(s) or openings 110 of the flat surface 107.

The flat surface 107 of the second end 106 of the curved portion 101 further comprise a lug 111, shown in FIG. 6 and FIG. 8. This lug 111 is intended to be inserted into a hole (not shown) formed on one face of the speaker 10, so as to secure the speaker 10 in its vertical position when it is fixed to the support. Thus, there is no risk of the speaker 10 pivoting about the screw passing through the opening 110 formed through the flat surface 107 of the curved portion 101. This is advantageous during the step of fixing the enclosure 10 to its support 15 (i.e. during installation), but also prevents the speaker 10 from pivoting due to the vibrations emitted during the operation of the speaker 10.

Here, the curved portion 101 has a thickness of between 3 mm and 6 mm, preferably 5 mm. Thus, the support 15 is sufficiently robust to maintain the speaker 10 vertically and to prevent it from tilting under the effect of its weight, and without causing oscillations to the speaker 10 on the support when a user manipulates it or due to the vibrations emitted during operation.

It is possible to make the curved portion 101 from plastic. However, there is a risk that the support 15 of the speaker 10 is not rigid enough and vibrates with the speaker 10.

To improve the rigidity of the support and to limit the vibrations of the speaker/support when the speaker 10 is operating, several embodiments are advantageous.

In a first embodiment, the curved portion 101 is made of metal (for example, aluminum) rather than plastic. In a particular embodiment, the entire support is made of metal, for example, the same metal as that used for the base 100 (for example, aluminum), in which case, the support 15 is a one-piece part of metal (which has the advantage of being robust and limiting vibrations compared to plastic).

In a second embodiment, the curved portion 101 is made of plastic but further comprise, a rib on the back of the curved portion. In a particular embodiment, the entire part is made of plastic, preferably in a one-piece, in which case the rib can be easily formed in the curved portion 101.

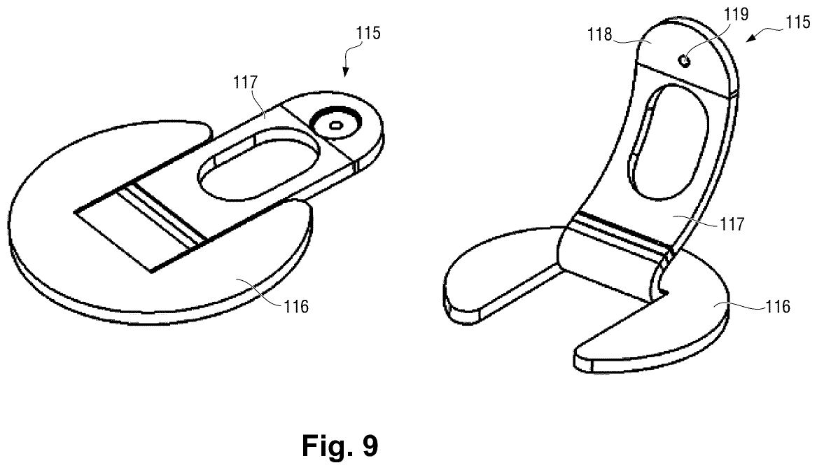

In a third embodiment, shown in FIG. 9, the support 115 can be made from a folding of a metal plate cutout (for example, aluminum). Advantageously, the support 115 is formed of a single part.

The left drawing of FIG. 9 shows the support 115 before the folding, and the right drawing shows the support 115 after the folding. Once again, the support 115 comprises a base 116 and a curved portion 117 having at its free end a flat surface 118, provided with a fixing hole 119, on which the speaker is fixed.

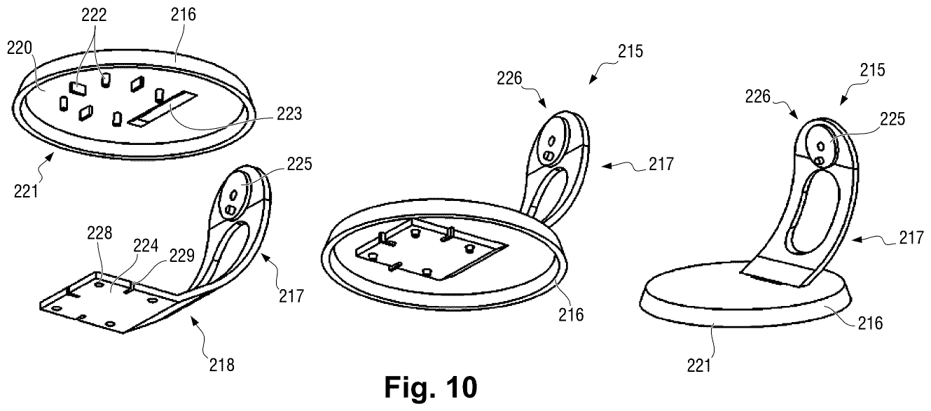

In a fourth embodiment, shown in FIG. 10, the support 215 can be split into two separate parts. By way of example, the support 215 then comprises a plastic stand 216 (the base) and a curved portion 217 made of metal. The first end 218 (tab) of the curved portion 217, made of metal (for example, aluminium), is headed onto the bottom 220 of the first face 221 of the base.

The heading is particularly advantageous for attaching the curved portion 217 onto the base 216 for the same reasons as previously indicated (i.e no additional parts, no risk of vibration, reduced bulk, very robust connection).

The plastic pins 222 extend vertically from the bottom 220 of the first face 221 of the base 216. The base 216 also comprises a slot 223.

The first end 218 of the curved portion 217 comprises a flat surface 224, that extends orthogonally to the flat surface 225 of the second end 226 of the curved portion. The flat surface 225 has the shape of a circular pellet. The flat surface 224 comprises holes 228, and slots 229 formed in the edges of the flat surface 224. Here, the flat surface 224 is square-shaped; the holes 228 are located in the corners of the flat surface 224 and the slots 229 are located at the midpoints of the three free edges of the flat surface 224.

The flat surface 224 is inserted into the slot 223 and then applied against the bottom 220 of the first face 221 of the base 216, such that the pins 222 are inserted into the holes 228 and the slots 229. The flat surface 224 is then fixed by heading at the bottom 220 of the first face 221 of the base 216.

Naturally, the invention is not limited to the embodiment described but comprises any variant entering into the field of the invention, such as defined by the claims.

The speaker comprising the protective part need does not necessarily have the shape of a capsule and, consequently, the curved surfaces of the protective part can be different from those described here.

The end box portion of the box, covered by the protective part, is not necessarily an upper face of the box. The end box portion of the box can be a left face or right face of the box. Similarly, the side box portion of the box, covered by the protective part, could be a different face of the box, for example, a rear face.

The positioning device and the fixing device could be different from those described here. In particular, the number and the position of the magnets, the pins and the tabs could be different. The tabs could for example, be replaced by elastic nesting elements, the pins could have a different shape, just like the magnets, etc.

1. A protective part, arranged to be assembled with a sound box which comprises a first side box portion and a first end box portion, the first side box portion being a front face and the first end box portion being an upper face of the sound box,
the first end box portion comprising a first convex external surface and extending from the first side box portion, the first side box portion of the sound box comprising a second convex external surface,
the sound box can comprise a first loudspeaker having its diaphragm positioned at the first side box portion and a second loudspeaker having its diaphragm positioned at the first end box portion,
the protective part comprising:
a side protective portion and an end protective portion, the end protective portion comprising a first concave inner surface, complementary to the first convex external surface, and extending from the side protective portion, the side protective portion comprising a second concave inner surface complementary to the second convex external surface;
a positioning device arranged to guide the protective part into a predefined position on the sound box during the assembly of the protective part with the sound box, and to maintain the protective part in this predefined position;
the protective part being arranged such that when assembled with the sound box, the side protective portion and the end protective portion of the protective part respectively cover the first side box portion and the first end box portion of the sound box, the protective part thus being arranged to protect the first loudspeaker and the second loudspeaker from the sound box.

2. The protective part according to claim 1, wherein the end protective portion extends such that, when the protective part is assembled with the sound box, the end protective portion also covers a part of a second side box portion of the sound box, opposite the first side box portion.

3. The protective part according to claim 1, wherein the side protective portion extends such that, when the protective part is assembled with the sound box, the side protective portion also covers a portion of a second end box portion of the sound box, opposite the first end box portion.

4. The protective part according to claim 1, the sound box comprising a central portion, cylindrically-shaped, and two hemispherically-shaped ends, the first side box portion belonging to the central portion and the first end box portion at one of the ends.

5. The protective part according to claim 1, the positioning device comprising at least one magnet which is positioned on an inner wall of the side protective portion and which is located near an edge of the side protective portion.

6. The protective part according to claim 5, comprising a first magnet positioned near an edge of a free end of the side protective portion, and two second magnets each positioned near a distinct side edge of the side protective portion and near the end protective portion.

7. The protective part according to claim 1, the positioning device further comprising at least one pin arranged to centre the protective part on the sound box during assembly of the protective part and the sound box, the at least one pin being positioned near an edge of a free end of the end protective portion, and being arranged to be assembled by elastic nesting in a complementary hole formed on the sound box.

8. The protective part according to claim 1, further comprising a fixing device arranged to fix and lock the protective part on the box, the fixing device comprising at least one tab that extends from an edge of a free end of the end protective portion and which is intended to be fixed to a second side box portion of the sound box, opposite the first side box portion.

9. The protective part according to claim 1, wherein at least one of the side protective portions and the end protective portion comprises holes intended to let out sounds generated by at least one loudspeaker of the sound box having a diaphragm positioned opposite said holes.

10. An acoustic speaker comprising the sound box and a protective part according to claim 1.

11. The acoustic speaker according to claim 10, wherein the sound boxcomprises at least one first loudspeaker having a diaphragm positioned at the first side box portion.

12. The acoustic speaker according to claim 10, the sound box comprising at least a second loudspeaker having a diaphragm positioned at the first end box portion.
